(19) United States
(12) Patent Application Publication
(10) Pub. No.: US 2003/0096081 A1
(43) Pub. Date: May 22, 2003

(54) Integrated microfluidic, optical and electronic devices and method for manufacturing

(76) Inventors: Guy P. Lavallee, State College, PA (US); Jeffrey M. Catchmark, Bellefonte, PA (US)

Correspondence Address: COLESANTI & ASSOCIATES LLC, 117 NORTH 15TH STREET, STE. 1505, PHILADELPHIA, PA, 19102, US

(21) Appl. No.: 10/035,374

(22) Filed: Oct. 19, 2001

(51) Int. Cl. B32B 3/10

(52) U.S. Cl. 428/138; 428/156

(57) ABSTRACT

The following invention relates to the application of PCB fabrication technology for producing micro fluidic devices useful for performing chemical or biological tests. In addition, optical and electronic devices are described which can be integrated with micro fluidic devices.

### FIELD OF THE INVENTION

The present invention relates to a novel production method for micro fluidic devices useful for performing tests on chemical or biological samples.

### BACKGROUND OF THE INVENTION

Devices for performing optical or electronic related analysis of chemical or biological samples are sought to lower the cost of these tests, improve the efficiency of testing and enable further research in many areas of biology and medicine. Current testing of biological samples can involve mixing a biological sample with some other compound or compounds and performing some type of analysis, such as, for example, an optical analysis, to determine if a given reaction has occurred. Examples of biological samples can be blood and/or body fluids. In this case, the detection of a reaction or lack of reaction of blood or a body fluid with another compound or compounds may provide an indication, for example, that a patient in a hospital or doctor's office exhibits a particular medical condition.

Currently, many of these tests are performed using test tubes and related fixtures and require significant human interaction. In addition, these tests can be time consuming, which translates to a low through put of tests in a given laboratory, and/or a limitation on the number of tests which can be efficiently performed. This situation translates to a high cost of performing tests, which limits the extent of testing practically available to, for example, a patient.

Other approaches for performing batch testing of chemicals or biological samples have been investigated. One of the most intensely explored approaches involves integrating many instruments and devices found in a given biological testing laboratory onto a Silicon chip, for example. This is the so-called ‘lab-on-a-chip’. Such a chip would be ideally disposable, and only used for one given series of tests. In this case, the test tubes are replaced with etched chambers and the interconnection of such chambers is accomplished using a micro-scale plumbing system composed of what is known as micro-fluidic channels. Micro-fluidic channels are small grooves or cylinders which are often rectangular in cross section which consist of a bottom, sides and top layer, all sealed to provide a enclosed channel. These micro-fluidic channels are used to transport fluids or fluids with some material contained in them from one point to another point. Micro-fluidic channels can be etched into Silicon, for example, and carry chemicals or biological samples from one chamber to another chamber also fabricated in Silicon. Typically, micro-fluidic channels are made to have small features, <100 microns in width and height, for example, to reduce the size of micro-fluidic devices, and to enhance the capillary transport effect, which can be exploited to move fluids along a micro-fluidic channel. Again, the objective of this integration is to facilitate the testing of many samples, or to perform many tests on a given sample in a simple, cost effective manner. Regardless of what specific test is being performed or how, ultimately an optical or electrical measurement is typically performed, requiring one or more optical or electrical devices or circuits to be needed. An example is a chamber as described above where two chemicals or biological materials are brought into contact. The interaction of those two materials may produce an optical characteristic which can be measured. Thus the chamber is a simple optical device storing the combined materials, but designed and produced in a way which allows some type of optical interrogation. This interrogation can be done, for example, by a person by inspecting a sample under a microscope or by a machine which can be performing some type of more complex analysis such as laser absorption spectroscopy. In any case, the chamber needs to be designed and fabricated to permit such interrogation. Similar statements can be made for electrical based measurements, where the material composing the ‘chip’ must permit, for example, electrical contacts or even circuits containing electronic or optoelectronic components or other devices or sensors, to be fabricated in or attached to the chip.

It would also be desirable to have a design and manufacturing platform which enables other processes known in the biological community to be implemented, such as electrophoresis. Electrophoresis, in which entities are moved through a medium as a result of an applied electric field, has become an increasingly indispensable tool in biotechnology and related fields. In electrophoresis, the electrophoretic medium through which the entities are moved is housed in an electrophoretic chamber. A variety of different chamber configurations find use, including slab gel holders, columns or tubes, microbore capillaries, grooves or channels on a substrate surface etc., where advantages and disadvantages are associated with each particular configuration. The ability to functionalize surfaces or to integrate metal contacts and dielectric materials in configurations which generate a desired electric field configuration would be important for Electrophoresis.

Moreover, the ability to place electrical components and metal interconnects could allow other devices to be fabricated, such as chambers with integrated heating elements and temperature monitoring devices such as thermocouples. In this case reactions could be monitored as a function of temperature, allowing other experiments to be performed.

Given the types of tests typically done and the large number of tests desired to be performed which necessitate a large chip to be designed, Silicon has not been exclusively studied as a chip material. This situation arises due to the relatively high cost of fabricating Silicon chips using conventional semiconductor processing techniques. It can cost ˜$1000 to process an 8-inch wafer with the simplest of features fabricated on it. The integration of more complex features or devices may increase the cost by 2-3 times. If only 10 chips can be obtained from a given 8-inch wafer, then the cost of a given chip can be ˜$100 or more. This cost does not include subsequent packaging or preparation for use in a laboratory, which may include lamination. Lamination is a process used to form the top layer of the micro-fluidic channel and typically involves the application of some type of polymer, as discussed below. In addition, this cost does not include the deposition of many different chemical or biological reactants into, for example, many different chambers fabricated on the chip enabling subsequent testing on a chemical or biological sample to be performed. These subsequent manufacturing processes can further increase the cost of the chip.

Although a cost of ˜$100 or more may be acceptable for specific testing applications, the bio-technology industry has searched for a means of substantially reducing the cost of these chips to facilitate their use in many applications, including, for example, testing in a doctor's office. In this case a standard disposable chip or set of chips would be purchased in quantity by a doctor who would also purchase any needed test equipment. Testing for various medical conditions would be done directly by a technician at the doctor's office using the chips and the required test equipment. This would reduce the cost and time required to do many tests.

To reduce the cost of the chip below what could potentially be attained using Silicon chip manufacturing technologies, other manufacturing and material technologies have been explored. Micro-fluidic channels have been fabricated in polymer or plastic materials using hot embossing and/or laser cutting processes. Embossing has the potential to be a low cost process, but currently this process has exhibited several difficulties in producing microfluidic channels. In addition, laser cutting and other required processes have limited through-put, which has again resulted in manufacturing difficulties and higher product cost. In addition, the use of polymer substrates limits the ability to integrate optical, optoelectronic and electronic devices, sensors and circuits.

What is needed is a method for producing low cost ‘lab-on-a-chip’ type products in large volumes containing optical, optoelectronic and electronic structures, components, devices, systems and circuits which easily interface with equipment and can be used to perform a vast array of chemical and biological testing.

### SUMMARY OF THE INVENTION

The following invention relates to a method for using established electronic printed circuit board (PCB) fabrication processes to the production of versatile, complex structures for performing an array of chemical and biological testing. Standard PCB design and fabrication processes are applied to the design and fabrication of ‘lab-on-a-chip’ type products containing optical, optoelectronic and/or electronic structures, components, devices and/or systems, enabling an array of chemical and biological testing to be performed. In addition, methods and apparatus are described for performing such optical and electrical testing.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 shows a schematic drawing of a large chamber and a small chamber connected with a micro fluidic channel;

FIG. 2 shows a schematic drawing of an optical waveguide integrated with a micro fluidic channel;

FIG. 3 shows a schematic drawing of electrical contacts integrated with a microfluidic channel;

FIG. 4 shows a schematic drawing of a large chamber connected to 20 smaller chambers using different sized micro fluidic channels; and

FIG. 5 shows the interconnection of a micro fluidic channel on the top of a PCB connected to a micro fluidic channel on the bottom of a PCB using a drilled via.

### DETAILED DESCRIPTION OF THE INVENTION

Printed circuit boards (PCBs) are manufactured in very large quantities using processes which have been established over the past 50+ years. A large PCB manufacturing company can produce millions of boards per week, which may contain several individual PCB products of differing design. Due to the long history of manufacturing, the PCB industry has developed a detailed understanding of materials and controlled processes related to the practice of their art. It is an object of this invention to show that these materials and processes can be selected and arranged to manufacture ‘lab-on-a-chip’ type products as described above.

An outline of a basic 1-layer PCB manufacturing process is shown in Table 1 below:

TABLE 1

| | |
|---|---|
| Step 1: | Start with a board with copper laminated on both sides. The |
| | board material is typically FR4 or a related material, but other |
| | materials can be used, if desired and compatible with the entire |
| | manufacturing process. |
| Step 2: | Fabricate any holes through the laminated board by drilling |
| | using a drill and bit, or by laser drilling (typical processes). |
| Step 3: | Deposit copper (by, for example, electro less plating) every- |
| | where, covering drilled holes. A gold plating step could be |
| | added here. |
| Step 4: | Apply photo resist and pattern using optical lithography as |
| | known to someone skilled in the art. |
| Step 5: | Plate additional copper to desired thickness (1-4 mils typical). |
| | Gold could be plated here after the copper, or in place of the |
| | copper, if desired. |
| Step 6: | Perform solder plate to mask copper for subsequent etching. |
| Step 7: | Strip photo resist. |
| Step 8: | Etch copper. |
| Step 9: | Strip solder. |
| Step 10: | Apply solder mask over bare copper, pattern and cure as needed. |
| | Solder mask is a photosensitive polymer which behaves like a |
| | resist. The solder mask is patterned using optical lithography. |
| | The PCB industry has developed many solder masks in a variety |
| | of colors (including transparent materials), which are extremely |
| | resistant to environmental degradation and degradation by |
| | coming into contact to corrosive materials. |
| Step 11: | Apply solder via a Hot Air solder Leveling (HAL) process. |
| Step 12: | Separate individual PCBs from the large PCB. |

These processes can be done on both sides of the PCB. The solder mask referred to in Step 10 above is a photosensitive polymer patterned using optical lithography, which behaves like a resist in the microelectronics industry, except the primary function of the solder mask is to resist the adhesion of solder during the reflow process step in the assembly and attachment of electronic components on a PCB. Many resist or photodefinable polymer materials such as those used in the microelectronics industry, can be used as a solder mask material. Within the context of the present invention, these materials are included as solder mask materials. The PCB industry has developed many solder masks in a variety of colors (including transparent materials), which are extremely resistant to environmental degradation and degradation by coming into contact to corrosive materials. To the inventors' knowledge, the biotechnology industry have not explored the application of PCB materials such as solder mask and PCB fabrication processes to the production of micro-fluidic and bio chip devices.

According to this invention a version of the above process is implemented to fabricate micro-fluidic channels, small and large chemical and biological material reaction and storage chambers, and any other known or related structures with, if so designed, integrated optical, optoelectronic and/or electronic structures, features, components, systems, circuits and/or sensors. Micro-fluidic channels and small reaction chambers can be fabricated on both sides of the PCB by using solder mask material. The solder mask material can form the sides of the channel or both the sides and the bottom of the channel. Moreover, a particular type of solder mask material known as Dry Film Resist can be used to fabricate the top layer of the micro-fluidic channel, as will be explained below.

In the case where the channel is fabricated using solder mask as both the bottom and the sides of the channel, a process such as described in Table II below can be employed:

TABLE 2
Follow basic process as outlined in Table I above.
Perform Step 10 in Table I above but do not pattern the solder mask. At
this point the PCB will have a complete coating of solder mask, including
the walls of the vias, which can be drilled, for example.
Repeat Step 10 above but during this step, pattern the solder mask with the
desired micro-fluidic channel configuration.
Complete remaining PCB fabrication process as desired.

Many sizes of micro-fluidic channels have been explored and implemented, and range from several microns to the millimeter scale. Using current PCB technology, a minimum channel width of 2-3 mils (50 to 75 microns) is achievable routinely in production. Smaller sizes are possible. The height of the channel depends on the solder mask material. Solder masks applied in a liquid form can produce layers in the ˜0.5 mil to ˜3 mil range. There is, however, dry film solder mask which is applied like a lamination (in a sheet), which can produce layers which are ˜1 mil to several mils thick. In fact, a particular type of solder mask material, known as dry film resist, can be used to fabricate all sides of a micro-fluidic channel. This will be discussed below. Thicker layers of solder mask can be obtained using liquid materials by recoating the board before exposure. For example, if the desired thickness of the solder mask layer is 1 mil, but the solder mask being used provides a thickness of 0.5 mils, then the board can simply be recoated before exposure. This process can apply to solder mask materials applied in both dry and liquid form.

In addition, other materials can be used as a solder mask. Materials common in the microelectronics industry such as resists or photosensitive polymers can be used. In particular, materials such as SU-8, Bizbenzocyclobutane (BCB) or other similar or related materials can be implemented.

The process described above in Table 1 produces a micro-fluidic channel with only 3 sides, where the width of the channel can be as large as is practical and as small as 2-3 mils, and the height can be from ˜0.5 mils or less to >3 mils. At this stage, the top of the channel needs to be fabricated. This can be done using lamination processes currently employed by companies manufacturing, for example, polymer or plastic chips as described above. In this case, both sides of the PCB would be laminated with a desired lamination material such as, for example, a transparent polymer or plastic material compatible with standards desired or required by the medical or biological community. Polymeric materials which could be used as a laminate include: polydimethylsiloxane, polymethylmehacrylate, polyurethane, polyvinylchloride, polystyrene, polysulfone, polycarbonate, polymethylpentene, polypropylene, polyethylene, polyvinylidine fluoride, and acrylonitrile-butadiene-styrene copolymer, or any materials, including but not limited to the foregoing, where the surface is functionalized to provide some desirable characteristics useful for performing biological and/or chemical analysis.

A method for producing micro-fluidic channels using PCB fabrication technology would then follow the process shown in Table 3 below.

TABLE 3

| | |
|---|---|
| Step 1: | Start with a board with copper laminated on both sides. The |
| | board material is typically FR4 or a similar or related material, |
| | but other materials can be used, if desired and compatable with |
| | the entire manufacturing process. |
| Step 2: | Fabricate any holes through the laminated board by drilling |
| | using a drill and bit, or by laser drilling (typical processes). |
| Step 3: | Deposit copper (by, for example, electro less plating) every- |
| | where, covering drilled holes. A gold plating step could be |
| | added here. |
| Step 4: | Apply photo resist and pattern using optical lithography as |
| | known to someone skilled in the art. |
| Step 5: | Plate additional copper to desired thickness (1-4 mils typical). |
| | Gold could be plated here after the copper, or in place of the |
| | copper, if desired. |
| Step 6: | Perform solder plate to mask copper for subsequent etching. |
| Step 7: | Strip photo resist. |
| Step 8: | Etch copper. |
| Step 9: | Strip solder. |
| Step 10: | Apply solder mask over bare copper and cure as needed. |
| Step 11: | Apply second layer of solder mask, pattern and cure as needed. |
| | Multiple layers of solder mask can be applied to obtained a |
| | desired thickness. |
| Step 12: | If desired, apply solder via a Hot Air solder Leveling (HAL) |
| | process. |
| Step 13: | Separate individual PCBs from the large PCB. |
| Step 14: | Laminate and seal both sides of the PCB using processes known |
| | to someone skilled in the art. |

Step 14 can be done before step 13.

Again, these process can be done on both sides of the PCB to provide 2-level micro-fluidic channels. In addition, the solder mask could also be reapplied, patterned and the board laminated again to make multi-dimensional micro-fluidic channels on the top or bottom side of the PCB.

The process described above also allows large chemical and biological sample reaction and storage chambers to be fabricated and connected with micro-fluidic channels. Mechanically drilled or laser drilled vias of sizes ranging from ˜8 mils to almost any size can be fabricated, coated in solder mask and sealed with the lamination process described above. Micro-fluidic channels are fabricated using the above process and can extend into these large chambers and serve to interconnect 2 or more chambers as desired. In addition, smaller chambers can be fabricated by just forming wide micro-fluidic channels.

Large micro fluidic channels can also be made by drilling slots into, or partially into, the PCB, using the same process described above for fabricating vias which would become reaction or storage chambers. The top and bottom of these channels would be composed of the laminate material, or a dry film resist as will be discussed below. The size of such a channel will be limited by the thickness of the board and the minimum and maximum widths of the slots which are able to be fabricated by available manufacturing processes.

What is not addressed above is a process for placing materials in the chambers. Again, these materials can be chemical or biological materials used for testing other chemical or biological samples. The chemical or biological sample to be tested will likely be introduced into a reaction chamber or storage chamber in the field which can be, for example, a doctor's office or hospital or research laboratory. However, specific tests to be performed on a large scale may require specific PCBs to be manufactured on a large scale which would contain reactive materials to be used in a test in the field. For example, one embodiment of the current invention is a large chamber connected to many smaller chambers which contain different chemical or biological materials used for subsequent testing. These materials would be placed into the smaller chambers before the PCB is shipped to the end user.

A process for fabricating a PCB containing chambers with predetermined chemical or biological materials shown in Table 4 below.

TABLE 4

| | |
|---|---|
| Step 1: | Start with a board with copper laminated on both sides. The |
| | board material is typically FR4 or a related material, but other |
| | materials can be used, if desired and compatible with the entire |
| | manufacturing process. |
| Step 2: | Fabricate any holes through the laminated board by drilling |
| | using a drill and bit, or by laser drilling (typical processes). |
| Step 3: | Deposit copper (by, for example, electro less plating) every- |
| | where, covering drilled holes. A gold plating step could be |
| | added here. |
| Step 4: | Apply photo resist and pattern using optical lithography as |
| | known to someone skilled in the art. |
| Step 5: | Plate additional copper to desired thickness (1-4 mils typical). |
| | Gold could be plated here after the copper, or in place of the |
| | copper, if desired. |
| Step 6: | Perform solder plate to mask copper for subsequent etching. |
| Step 7: | Strip photo resist. |
| Step 8: | Etch copper. |
| Step 9: | Strip solder. |
| Step 10: | Apply solder mask over bare copper and cure as needed. |
| Step 11: | Apply second layer of solder mask, pattern and cure as needed. |
| | Multiple layers of solder mask can be applied to obtained a |
| | desired thickness. |
| Step 12: | Apply solder via a Hot Air solder Leveling (HAL) process (if |
| | desired). |
| Step 13: | Separate individual PCBs from the large PCB. |
| Step 14: | If needed, ship PCBs in sterile package (if needed) to company |
| | performing lamination and chemical and/or biological material |
| | functionalization of PCB. |
| Step 15: | Laminate bottom side of the PCB using processes known to |
| | someone skilled in the art. |
| Step 16: | Deposit any number of different chemical or biological materials |
| | in any number of predesigned smaller chambers. The number of |
| | chambers is only limited to the desired size of the chamber and |
| | the size of the PCB. The injection of chemical and biological |
| | materials can be done automatically by using an adaptation of |
| | current electronic component ‘pick and place’ equipment, which |
| | can with ˜1 mil or less tolerance, align a robotic like assembly, |
| | which could contain one or more heads for injecting chemical or |
| | biological materials into the chambers. |
| Step 17: | Laminate top surface of the PCB and seal PCB. |
| Step 18: | Ship to end user. |

Of course, a small chamber produced by expanding a micro fluidic channel could also be functionalized as described above, eliminating a drilling step for every reaction chamber. This may further decrease the manufacturing time of PCBs containing hundreds of chambers by allowing such chambers to be lithographically defined rather than mechanically drilled.

Another method for forming a completely enclosed micro fluidic channel involves the use of a dry film resist as the top of the channel as well. Dry film resist materials are used as solder masking materials and are desirable for applications where the thickness of the layer is desired to be on the order of 1 mil or greater. Most dry film resists are photo definable. There are many dry film resists available including Vacrel and Riston films from Dupont. The process for applying this film is similar to a lamination process. The dry film resist is delivered in rolls or sheets and is applied as a sheet over the PCB. In some application processes, the film and/or the PCB are heated. The use of dry film resists to cover a drilled hole in a PCB is well known and is called ‘tenting’. To the inventors' knowledge, such dry film resists have never been used to fabricate, or laminate to seal, a micro-fluidic channel or chamber, where the dry film resists would ‘tent’ over a channel to enclose the channel. In addition, the use of a dry film resist can allow the fabrication of multi-layer micro-fluidic channels on either side of a PCB.

In addition, the use of photo definable dry film resists opens the possibility of fabricating complex micro fluidic devices such as micro fluidic channels and chambers on other substrates other than those used to make PCBs. The use of dry film resist as either the top of a micro fluidic channel or chamber, or as the top, bottom and sides of a micro fluidic channel or chamber, can be applied to the fabrication of micro fluidic devices on substrates such as Silicon, other polymer substrates such as plastic or even metal substrates such as stainless steel. These substrates can be unpatterned and the micro fluidic channels can be fabricated completely using layers of resists where the final top layer is a dry film resist or other polymer laminate. Alternatively, these substrates can be patterned to exhibit channels or chambers where the sides or even the sides and bottom of the channels or chambers are composed of the substrate material and only the top and bottom, or only the top, of the channel or chamber is composed of the dry film resist. An example is a channel etched in Silicon where the top of the channel is dry film resist. Another example is a stamped or drilled stainless steel sheet where the sides of the micro-fluidic channel are formed using the stamping or drilling process and where the top and bottom of the channel are formed using the dry film resist. Many other examples can be developed.

In the field, a chemical or biological material to be tested can be inserted into what can be called a distribution chamber by using a sterile ‘punch’ which could open a hole in the top layer laminate allowing a needle or pipette to inject a liquid material to be tested into the chamber. The use of a needle may not require a punched laminate, if, for example, the bottom laminate material could be made more resistant to puncture or if the needle could be inserted with precision either by a person or automatically by using a machine.

Of course, more than one chamber could be used. For example, a hole could be punched into one chamber and a solid material placed into the chamber. Then another hole could be punched into a neighboring chamber and a liquid material intended to dissolve, react, or aid the interaction of the solid test material with other reactants in other smaller chambers. The chamber with the solid material and the chamber with the liquid material can be connected with a micro-fluidic channel and the chamber with the solid can be connected to many other reaction chambers with, for example, smaller micro-fluidic channels.

If it is necessary to seal the top surface after a hole has been punched or a needle injected into the laminate, then a smaller sterile laminate could be used to cover the hole.

The rate of flow of fluids from one chamber to one or more other chambers can be tailored by changing the width of the micro-fluidic channel, as known to those familiar with the design of such channels.

In addition, yet another large chamber can be fabricated using a drilled via laminated on both sides as described above and connected to one or more smaller chambers with a large micro-fluidic channel. This large chamber can be used to serve as a means of applying a pressure to fluids in other chambers by having an individual depress or squeeze the large chamber, deforming the laminate on both sides, reducing the volume of the large chamber, forcing air into the other connected smaller chambers, causing the fluid to flow. In this case, it may be desirable to locate the micro-fluidic channels connecting the smaller chambers to other chambers on the bottom of the PCB so that fluid always covers the channel while the pressure is being applied, allowing a uniform flow of fluid.

An alternative is to connect a pump or pressurized line to the larger chamber. A needle or tube like device connected to a pump or pressurized container containing some type of gas, which could be inert of even reactive in some desirable way, could be inserted into the larger chamber providing the pressurization function forcing the fluid to flow through the channels.

As described above, large or small chambers can be connected to other chambers using micro-fluidic channels. Smaller chambers or vias can be used to provide connections between a micro-fluidic channel located on the top surface of the PCB and one located on the bottom surface of the PCB. These vias can be made small (200 microns or less). By using these vias to interconnect channels on the top side and the bottom side of the PCB, many micro-fluidic channel arrangements can be developed.

An important aspect of fabricating ‘lab-on-a-chip’ devices is the ability to integrate electronic and/or optoelectronic devices and/or sensors for performing or aiding in the performing of any type of electrical, optical and/or chemical analysis. One of the most basic requirements for accomplishing this is to establish the ability to run electrical interconnect lines anywhere on the chip so that devices or electronic structures can be connected and mounted and, for example, electrical signals generated or modified by a device or electronic structure, can be delivered to test equipment located externally to the chip. PCB fabrication technology is ideal for this application, since PCBs with as many as 18 metal interconnect layers separated by a dielectric can be fabricated, permitting very complex interconnect systems to be implemented. An example of this fabrication process is given in steps 1-9 in Table 1 above. Such complex interconnection systems can be fabricated under the micro-fluidic channels, allowing devices or electronic structures to be placed anywhere on the PCB. In addition, as is routinely done in the computer industry, for example, the electrical interconnects can be fabricated so that they extend to the edge of the PCB and are designed so that they interface electrically and mechanically with another electronic and mechanical structure to provide electrical interconnection to some circuit, system or test equipment external to the PCB. This type of electrical and mechanical system can be integrated onto a PCB containing any of the micro-fluidic devices or chambers described above, allowing the PCB to be plugged into a fixture which could perform any kind of electrical interrogation or monitoring of devices, sensors and/or electronic structures located on the PCB.

In addition, resistive elements could be integrated with small chambers as described above, allowing the temperature of reaction chambers to be increased or decreased, and monitored by mounting a temperature sensing device, such as a thermocouple, near or on the chamber. In fact, a thermoelectric cooler/heater (TEC) can be mounted upon a small or large chamber, allowing the temperature of the contents of the chamber to be varied over a wide range. Since the PCB can be processed both sides, the TEC can be positioned on the bottom of the PCB allowing the contents of a large chamber, for example, to be examined from the top. The TEC itself can be metalized with a reflective material, for example, forming an optical cavity allowing other optical characterizations to be performed such as double pass absorption spectroscopy.

Since the PCB can be processed on both sides, other device geometries allowing the analysis of chemical or biological materials can be implemented. Using standard surface mount device attachment processes employing reflow solder or epoxy bonding as known to one skilled in the art, an LED or laser can be mounted on one side of a large chamber and a photodiode or other photoconductive element mounted on the other side of a large chamber. Light propagating from the LED, for example, would pass through the chamber, and any material in the chamber, before entering the photodiode. The light entering the photodiode could be measured before any material enters the chamber providing a baseline for the measurement. Other device geometries will become apparent to one skilled in the art.

Other devices have also been considered for the analysis or transport of chemical or biological materials including acoustic transducers and even electric field induced transport through a process known as electrophoresis. In the case of acoustic driven flow, acoustic transducers can be easily mounted onto the surface of a PCB over a micro fluidic channel or a chamber (to, for example, provide a mixing type of function). Direct current or time varying electric signals can be transported on electrical contacts on the PCB to activate the acoustic transducer.

In the case of electrophoresis, many different electrical contact geometries can be developed to introduce an electric field into a small or large micro fluidic channel or chamber as described above. In fact, by integrating various contact geometries with multiple micro fluidic channels and chambers, many types of biological sorting structures can be developed, as will be apparent to one skilled in the art. In addition, the contacts can be isolated from the chemical or biological material by a thin layer of solder mask or the thin layer of solder mask can be opened to expose the metal contact to the inside of a micro fluidic channel or chamber. This is discussed in the next paragraph.

The integration of electrical interconnect structures with micro-fluidic channels also opens up the possibility of performing new types of electrical characterization of fluid or a combination of fluid and non-fluid chemical and/or biological materials. For example, two electrical interconnects can be fabricated underneath a micro fluidic channel and the solder mask over the metal interconnects removed so that the bottom of the channel is the surface of the interconnect metal. These two interconnect lines which intersect with the micro-fluidic channel can be spaced as closely as 50 microns or less. Alternatively, a much smaller spacing of electrodes can be realized by forming a continuous electrode and laser cutting or ablating the metal in a predefined region of the electrode forming 2 electrodes separated by a very thin space or gap. These gaps can be <1 micron wide. By applying a direct current or time varying signal or signals on these interconnect lines, new types of electrical based analysis of chemical or biological samples can be developed. For example, the complex electrical impedance of the chemical or biological material can be characterized as a function of frequency over a wide range of values extending into the multi-gigahertz range. Another test could be a test of the nonlinearity response of the chemical or biological material by exciting the material with 2 or more electronic signals or tones at different frequencies and measuring intermodulation distortion products. Again these electronic signals can be delivered by using the PCB interconnect lines. Since such gaps can be <1 micron wide, RF measurements can be used potentially to identify proteins, for example, flowing in a microfluidic channel. This would be done by functionalizing the metal contacts on both sides of the gap and measuring some RF response of proteins, for example, bridging the gap. These interconnects can also be integrated into small or large chambers. This invention integrates such electronic structures, such as micro-fluidic channels with patterned electrical contacts on the bottom surface of the channel, enabling new and/or existing electronic testing of chemical and/or biological materials. These contact geometries, and variations thereof, could also be exploited for electrophoresis.

One of the most common reason, however, for placing electrical interconnect lines down on a PCB is to connect and secure electronic or optoelectronic devices. This invention provides a chemical and/or biological analysis platform based on PCB technology which enables the integration of electronic or optoelectronic components by mounting and connecting such components using patterned metal interconnect pads and standard pick-and-place and reflow solder or epoxy technologies.

An example of such a process is given in Table 5 below:

TABLE 5

| | |
|---|---|
| Step 1: | Start with a board with copper laminated on both sides. The |
| | board material is typically FR4 or a related material, but other |
| | materials can be used, if desired and compatible with the entire |
| | manufacturing process. |
| Step 2: | Fabricate any holes through the laminated board by drilling |
| | using a drill and bit, or by laser drilling (typical processes). |
| Step 3: | Deposit copper (by, for example, electro less plating) every- |
| | where, covering drilled holes. A gold plating step could be |
| | added here. |
| Step 4: | Apply photo resist and pattern copper interconnect lines and |
| | bond pads using optical lithography as known to someone skilled |
| | in the art. |
| Step 5: | Plate additional copper to desired thickness (1-4 mils typical). |
| | Gold could be plated here after the copper, or in place of the |
| | copper, if desired. |
| Step 6: | Perform solder plate to mask copper for subsequent etching. |
| Step 7: | Strip photo resist. |
| Step 8: | Etch copper. |
| Step 9: | Strip solder. |
| Step 10: | Apply solder mask over bare copper and cure as needed. |
| Step 11: | Apply second layer of solder mask, pattern and cure as needed. |
| | Multiple layers of solder mask can be applied to obtained a |
| | desired thickness. |
| Step 12: | Apply solder via a Hot Air solder Leveling (HAL) process |
| | (if desired). |
| Step 13: | If needed, ship PCBs in sterile package (if needed) to company |
| | performing lamination and chemical and/or biological material |
| | functionalization of PCB. |
| Step 14: | Laminate bottom side of the PCB using processes known to |
| | someone skilled in the art. |
| Step 15: | Deposit any number of different chemical or biological materials |
| | in any number of predesigned smaller chambers. The number of |
| | chambers is only limited to the desired size of the chamber and |
| | the size of the PCB. The injection of chemical and biological |
| | materials can be done automatically by using an adaptation of |
| | current electronic component ‘pick and place’ equipment, which |
| | can with ˜1 mil or less tolerance, align a robotic like assembly, |
| | which could contain one or more heads for injecting chemical or |
| | biological materials into the chambers. |
| Step 16: | Laminate top surface of the PCB and seal PCB. |
| Step 17: | Apply photo resist and pattern to perform an etching process to |
| | remove the lamination in select areas over the copper inter- |
| | connect lines and bond pads using optical lithography as known |
| | to someone skilled in the art. If dry film resist is used as the |
| | laminate, optical lithography would be used directly to pattern |
| | the laminate. |
| Step 18: | Clean and separate individual PCBs. |
| Step 19: | Mount electronic and/or optoelectronic devices on the PCB using |
| | pick and place equipment and bond to the metal bond pads using |
| | reflow solder processes or epoxy attachment processes. |
| Step 20: | Ship to end user. |

Another important requirement of a lab-on-a-chip type device is the ability to perform optical characterization of chemical or biological materials located, for example, in micro-fluidic channels or small or large chambers as described above. This invention provides a way of integrating optical waveguides onto a PCB and interfacing those waveguides with micro-fluidic channels. Another aspect of this invention is to fabricate small or large chambers, which could, for example, be storing chemical or biological materials which have undergone some type of reaction, where such chambers have been designed to facilitate optical analysis.

Waveguides can be fabricated on the surface of a PCB in several manners. One method is to use transparent solder mask material, or some other material as a replacement for the solder mask material such as, for example, SU-8, Bizbenzocyclobutane (BCB), photosensitive polymers or any other similar or related materials. In this case, a waveguide would be formed by either using two different solder mask materials where the first layer deposited would have a lower index of refraction than the second layer deposited and the second layer would be patterned as described above forming a ridge which would confine the light as known to anyone skilled in the art of waveguide design. The waveguide would then be defined by an air-solder mask interface on the 2 vertical sides, and a solder mask—solder mask interface on the bottom side. The top side would also have a lamination layer attached as described above, which would form the top surface of the waveguide. The lamination material should be transparent and should have the same or lower index of refraction relative to the solder mask. Since the laminate is the final top layer, then the laminate-air interface also becomes a part of the waveguide structure, and forms the top of the waveguide structure. This is also true if the laminate is a dry film resist as described above.

Since the top layer of solder mask is also used to form the micro-fluidic channels, the optical waveguide would then directly align with the channel, allowing optical analyses to be performed on materials in the channel using light transported in the solder mask waveguides.

The channels patterned in the top solder mask would have to be isolated from the micro-fluidic channels, which would be done by leaving a section of unpatterned solder mask between the different channel structures isolating the micro-fluidic channel. Since the waveguides would typically be large in, for example, width and typically multi-moded, coupling from one waveguide on one side of a micro-fluidic channel to the waveguide on the other side of the micro-fluidic channel could be accomplished with a minimum of optical losses, since larger optical beams typically diffract less. This will become more apparent in the detailed description of the preferred embodiments.

Another method for forming an optical waveguide in the event that, for example, only one transparent solder mask could be used is to have the bottom of the waveguide be metal instead of a solder mask material. The metal could be, for example, copper or gold coated copper. One way this could be accomplished is to pattern both the top and bottom layers of solder mask and design the PCB so a layer of metal was patterned underneath the two patterned layers of solder mask. In this case, the two patterned layers of solder mask would become the ridge waveguide.

Optical signals can be introduced or coupled into these waveguides in several ways. One way is to flip-chip bond a laser diode or light emitting diode (LED) directly onto the PCB where the output of the laser diode is aligned to an end of a patterned solder mask waveguide. Since these waveguides can be made large (25 microns by 50 microns or more), alignment of the laser diode's or LEDs output to the waveguide would be achievable. In fact, an entire optical circuit could be integrated onto the PCB. Photodiodes where the active region is located parallel to the plane of the PCB could also be flip-chip mounted and aligned to the solder mask waveguides and perform the function of monitoring optical signals. The electrical interconnect lines could transport any electrical signals generated by the laser diode, LED or photodiode, for example, to other electronic devices of off the PCB to other test equipment.

Another approach would be to just pattern the optical waveguides so that they extend to the edge of the PCB. After the individual PCBs are separated, the edges of PCBs could be ground and/or polished forming a clean, smooth waveguide edge. The PCB could then be designed with mechanical alignment features and be plugged into a fixture containing mechanical alignment features and either optical waveguides or lasers, LEDs and/or photodiodes, which would in turn be connected to other devices or test equipment. This approach eliminates the need for placing devices directly on the PCB.

Yet another structure which facilitates the optical analysis of chemical and/or biological materials is the large storage and/or reaction chambers described above formed by laminating and sealing both the top and bottom of a drilled through hole in a PCB. This chamber can be interfaced with many other chambers and/or structures using micro-fluidic channels as described above. By choosing a transparent laminate, chemical or biological materials can be imaged or analyzed optically by passing light or an optical beam through the top laminate, through the material and then through the bottom laminate. This could be done using a microscope or other optical apparatus.

This invention provides an optical system for automatically characterizing optically biological and/or chemical materials contained is such chambers. As is known to those skilled in the art, single mode or multimode fiber optic waveguides can be attached to collimators, which are lens systems used to expand an optical beam propagating from an optical fiber, or to focus an optical beam into an optical fiber. Such an expanded beam can be on the order of several hundred microns wide to several millimeters wide and the collimators can produce such a beam in a configuration where the beam is focused to infinity, which means that the diffraction of the beam is very small and limited essentially to the size of the beam itself. By using 2 of these collimators mounted facing each other on both sides of the PCB using a movable fixture, light from an optical fiber can be expanded, passed through one of the chambers described above fabricated using transparent lamination material, and refocused into an optical fiber to complete an optical circuit. The fibers attached to the collimators can be connected to optical test equipment of any kind useful for characterizing the biological and/or chemical materials. Such equipment can consist of, for example, an optical source and a spectrum analyzer to perform optical absorption spectroscopy. Many other tests and configurations will be apparent to someone skilled in the art.

In addition, the collimators can be replaced with fiber bundles or even a camera and imaging system useful for visually inspecting the contents of such a chamber.

This invention enables the automated systematic optical, electrical or other analysis of biological and/or chemical materials. Any of the apparatus described above including the collimators or camera system can be mounted on a movable fixture enabling the automatic, systematic analysis of multiple chambers on a given PCB. In fact, special marks on the PCB itself can be fabricated enabling a computer controlled electronic vision system to identify the position of multiple chambers, as is done with the alignment and placement of electronic components in pick and place manufacturing equipment. The PCB could be simply inserted into a fixture and the subsequent analysis can be done automatically.

Finally, the small and/or large chambers described above can be coated or functionalized with special materials promoting or facilitating some chemical or biological process or processes. For example, after performing the bottom lamination of the PCB, the bottom of the chambers could be coated with a polymer such as, for example, Bizbenzocyclobutane, which could provide a surface for the growth and cultivation of biological materials such as, for example, biological cells. Other materials which could be used to coat such chambers include functionalized polystyrene spheres available from several manufacturers including Bangs Laboratories. These spheres are delivered in solution and can be obtained in several sizes ranging from ˜20 nanometers in diameter to several microns in diameter. These spheres can also be functionalized to exhibit positive and/or negative charge, which may be important, for example, for the attachment and/or cultivation of biological cells. Other chemical functionalizations are also available. These spheres can also be used to coat almost any surface to enable the cultivation and growth of biological cells.

Such a process for coating the bottom area of a chamber with some desired material as discussed above is described in Table 6 below:

TABLE 6

| | |
|---|---|
| Step 1: | Start with a board with copper laminated on both sides. The |
| | board material is typically FR4 or a related material, but other |
| | materials can be used, if desired and compatible with the entire |
| | manufacturing process. |
| Step 2: | Fabricate any holes through the laminated board by drilling |
| | using a drill and bit, or by laser drilling (typical processes). |
| Step 3: | Deposit copper (by, for example, electro less plating) every- |
| | where, covering drilled holes. A gold plating step could be |
| | added here. |
| Step 4: | Apply photo resist and pattern copper interconnect lines and |
| | bond pads using optical lithography as known to someone skilled |
| | in the art. |
| Step 5: | Plate additional copper to desired thickness (1-4 mils typical). |
| | Gold could be plated here after the copper, or in place of the |
| | copper, if desired. |
| Step 6: | Perform solder plate to mask copper for subsequent etching. |
| Step 7: | Strip photo resist. |
| Step 8: | Etch copper. |
| Step 9: | Strip solder. |
| Step 10: | Apply solder mask over bare copper and cure as needed. |
| Step 11: | Apply second layer of solder mask, pattern and cure as needed. |
| | Multiple layers of solder mask can be applied to obtained a |
| | desired thickness. |
| Step 12: | Apply solder via a Hot Air solder Leveling (HAL) process (if |
| | desired). |
| Step 13: | If needed, ship PCBs in sterile package (if needed) to company |
| | performing lamination and chemical and/or biological material |
| | functionalization of PCB. |
| Step 14: | Laminate bottom side of the PCB using processes known to |
| | someone skilled in the art. |
| Step 15: | Deposit any number of different chemical or biological materials |
| | in any number of predesigned smaller chambers. The number of |
| | chambers is only limited to the desired size of the chamber and |
| | the size of the PCB. The injection of chemical and biological |
| | materials can be done automatically by using an adaptation of |
| | current electronic component ‘pick and place’ equipment, which |
| | can with ˜1 mil or less tolerance, align a robotic like assembly, |
| | which could contain one or more heads for injecting chemical or |
| | biological materials into the chambers. |
| Step 16: | Deposit a controlled amount of Bizbenzocyclobutane into any |
| | desired chambers. |
| Step 17: | Cure the Bizbenzocyclobutane as needed. |
| Step 18: | Laminate top surface of the PCB and seal PCB. |
| Step 19: | If desired, Apply photo resist and pattern to perform an etching |
| | process to remove the lamination in select areas over the copper |
| | interconnect lines and bond pads using optical lithography as |
| | known to someone skilled in the art. |
| Step 20: | Clean and separate individual PCBs. |
| Step 21: | If desired, Mount electronic and/or optoelectronic devices on the |
| | PCB using pick and place equipment and bond to the metal bond |
| | pads using reflow solder processes or epoxy attachment |
| | processes. |
| Step 22: | Perform any testing/quality control procedures. |
| Step 23: | Ship to end user |

Many of the above inventions will become more apparent by examining several preferred embodiments. Devices such as H-filters, cyclometers and DNA sorters can be produced using the teachings of the present invention. Clearly, many variations on these examples will become apparent to anyone skilled in the art and none of these examples are meant to be limiting.

### DETAILED DESCRIPTION OF THE PREFERRED EMBODIMENTS

Embodiment 1: Micro-Fluidic Channel Test Structures

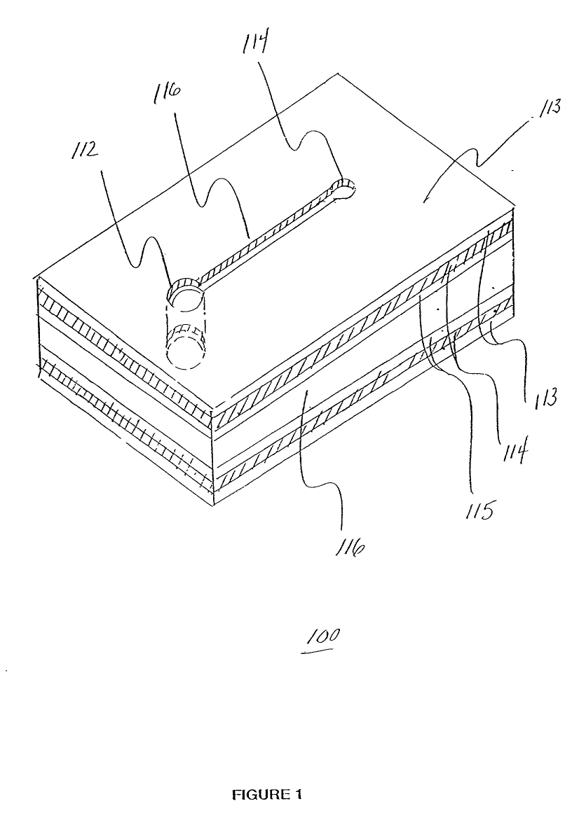

An exemplary embodiment of a micro-fluidic channel linking a large and small chamber fabricated on a PCB in accordance with the teachings of the present invention is shown in FIG. 1. The large chamber 12 is fabricated using drilled vias, and the smaller chamber 14 is fabricated by essentially expanding the micro-fluidic channel width and shape to form a larger cavity. The fabrication process followed that described in Table 3. The width of the micro-fluidic channel 16 can be 2 mils to over 8 mils.

Embodiment 2: Micro-Fluidic Channel with Integrated Optical Waveguide

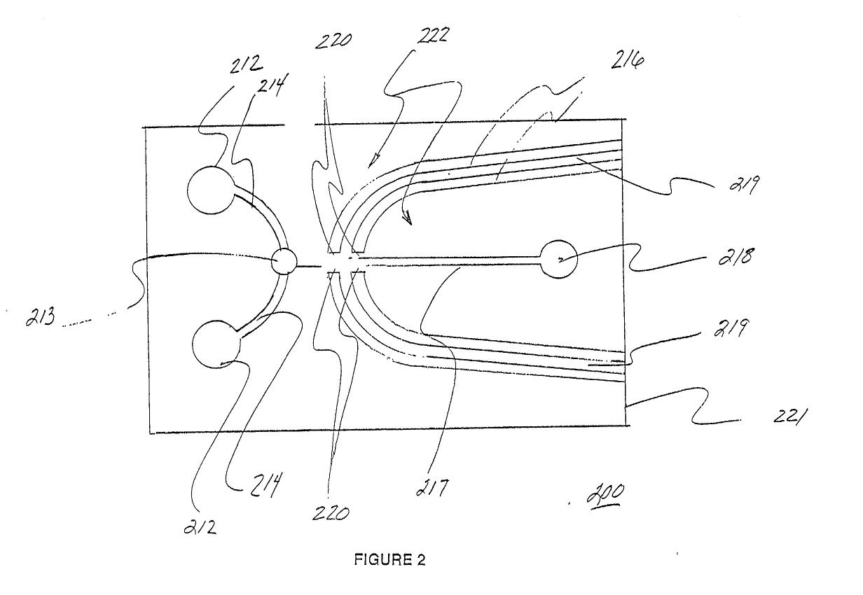

In the present embodiment, two micro-fluidic 216 channels were fabricated connecting two large chambers 212 to a reaction chamber 213 and a third channel 217 connecting the reaction chamber 213 to a final waste chamber 218. This is shown in FIG. 2. The reaction chamber was fabricated using an expanded micro-fluidic channel. The other chambers were drilled vias. In addition, an optical waveguide 219 was fabricated as described above which intersected with the micro-fluidic channel. The space between the two channels used to form the cladding part of the waveguide and the micro-fluidic channel serves to isolate the micro-fluidic channel.

Embodiment 3: Micro-Fluidic Channel with Integrated Electrical Interconnects

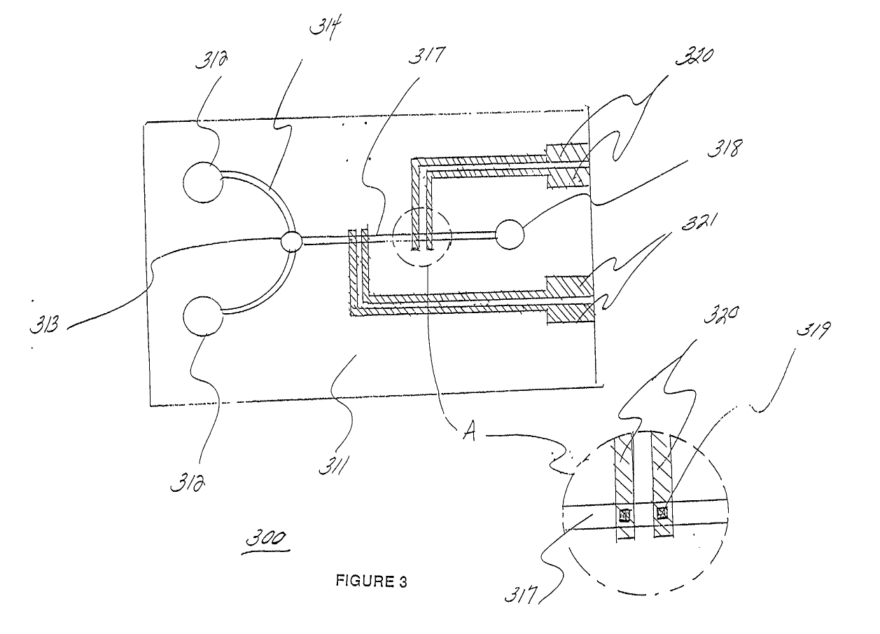

Two sets of two electrical contacts 320 extend from the side of the PCB 311 to intersect with the micro-fluidic channel 317 and, in the region 312 where the contacts and the micro-fluidic channel intersect, the first layer of solder mask has been opened to expose the electrical contact to the channel area. This is shown in FIG. 3. This allows electrical measurements to be performed. Measurements employing time varying signals can still be performed without opening the first layer of solder mask. Two sets are shown for illustrative purposes only. Any number of contacts in any configuration is possible. In addition, multiple contacts can be implemented for electrophoresis. These contacts can range in width from about 3 mils to any desired width, and can be separated by approximately 3 mils.

Embodiment 4: Distribution and Reaction System

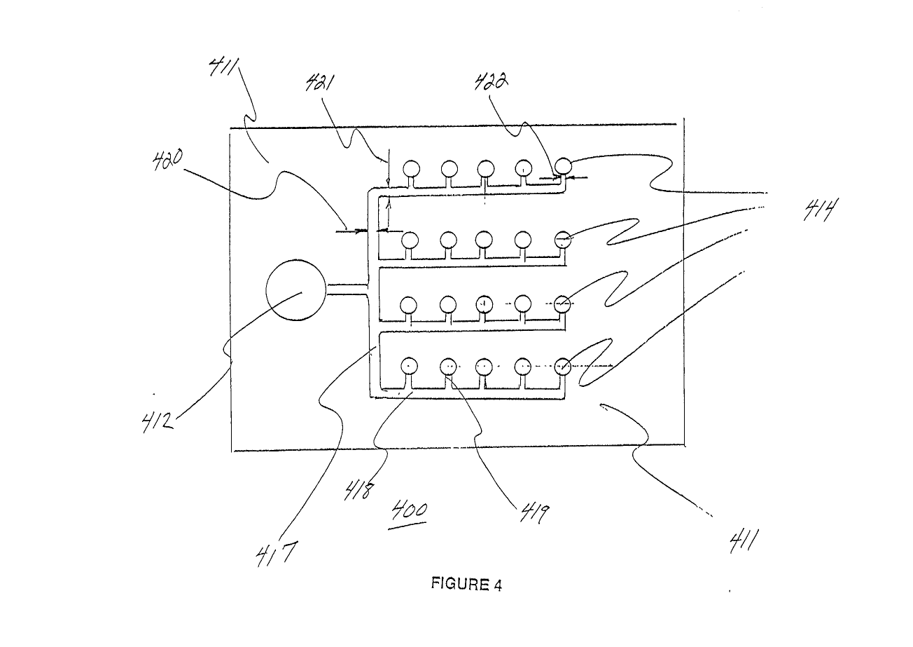

FIG. 4 shows a large chamber 412 connected to 20 smaller chambers 414 which can be functionalized as desired in accordance with the teachings of the present invention. The chambers are connected with micro fluidic channels. The width of the micro fluidic channels has been varied to control the flow of fluid as known to one skilled in the art. Such a device would allow the simplified mass testing of a chemical or biological material. Although only 20 chambers are shown, PCB layouts containing hundreds of chambers are possible.

Embodiment 5: Vias Connecting Micro-Fluidic Channels

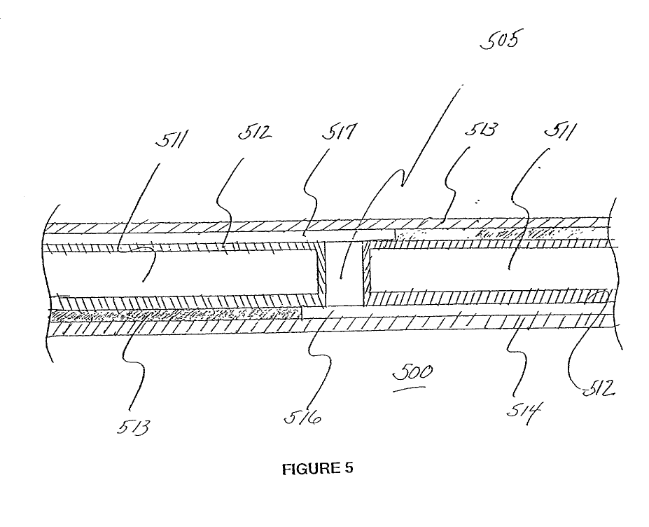

Drilled vias 505 can also be used to connect micro fluidic channels 516 and 517 located on the top and bottom surface of the PCB. This is shown in FIG. 5. The via 505 can be any size, but smaller vias are desired. Currently, vias with minimum diameters of about 8 mils are possible. For simplicity, the PCB is shown with no copper traces.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is as follows:

1. A device for storing, transporting, mixing or analyzing biological or chemical materials comprising:
a substrate;
a first layer of solder mask disposed on the substrate, the first layer of solder mask having a microfluidic groove;
a laminate disposed on the solder mask, wherein a microfluidic channel is formed by the microfluidic groove and the first layer of solder mask.

2. The device of claim 1 wherein the substrate is a metal laminated dielectric material.

3. The device of claim 2 wherein the metal laminated dielectric comprises copper.

4. The device of claim 2 wherein the metal laminated dielectric material comprises copper and gold layers.

5. The device of claim 2 wherein the metal laminated dielectric material is plastic, polymer, glass or paper.

6. The device of claim 2 wherein the metal laminated dielectric material is FR4 or fiberglass.

7. The device of claim 1 wherein the substrate comprises plastic.

8. The device of claim 1 wherein the substrate comprises a polymer.

9. The device of claim 1 wherein the substrate is metal.

10. The device of claim 1 further comprising first and second storage chambers connected by the micro fluidic channel.

11. The device of claim 10 wherein the first storage chamber contains a biological or a chemical material.

12. The device of claim 11 wherein the first storage chamber contains a material to facilitate the growth or sustenance of biological material.

13. The device of claim 11 wherein the first storage chamber is coated with a material to facilitate the growth or sustenance of biological material.

14. The device of claim 12 wherein the material is Bizbenzocyclobutane (BCB).

15. The device of claim 13 wherein the material is Bizbenzocyclobutane (BCB).

16. The device of claim 1 wherein the solder mask is a dry film resist or resist sheet.

17. The device of claim 1 wherein the laminate is a dry film resist or resist sheet.

18. The device of claim 1 further comprising an additional layer of solder mask in between the substrate and the first layer of solder mask.

19. The device of claim 18 wherein the additional layer of solder mask is a dry film resist or resist sheet.

20. The device of claim 16 wherein the dry film resist is Vacrel or Riston film.

21. The device of claim 17 wherein the dry film resist is Vacrel or Riston film.

22. The dry film resist of claim 18 where the dry film resist is Vacrel or Riston film.

23. A device for storing, transporting, mixing or analyzing biological or chemical materials comprising:
a patterned substrate having a top surface and a bottom surface wherein the pattern extends through the substrate to the top and bottom surfaces;
a laminate material disposed on the bottom surface of the substrate forming a bottom surface of the device.
a laminate material disposed on the top surface of the substrate forming a top surface of the device.

24. The device of claim 23 wherein the substrate is a metal laminated dielectric material.

25. The device of claim 24 wherein the metal is copper or copper with a layer of gold disposed on top of the copper.

26. The device of claim 24 wherein the dielectric is polymer, glass or paper.

27. The device of claim 24 wherein the dielectric is FR4 or fiberglass material.

28. The device of claim 23 wherein the substrate is a polymer or plastic.

29. The device of claim 23 wherein the substrate is metal.

30. The device of claim 23 wherein the patterned substrate and the laminate materials disposed on the top and bottom surfaces of the patterned substrate together define at least one micro-fluidic channel or chamber.

31. The device of claim 30 wherein the patterned substrate and the laminate materials disposed on the top and bottom surfaces of the patterned substrate together define first and second chambers connected by a first micro fluidic channel.

32. The device of claim 31 wherein the first chamber contains a biological or chemical material.

33. The device of claim 32 wherein the first chamber contains a material to facilitate the growth or sustenance of biological materials.

34. The device of claim 32 wherein the storage chamber is coated with a material to facilitate the growth or sustenance of biological materials.

35. The device of claim 33 wherein the material is Bizbenzocyclobutane (BCB).

36. The device of claim 34 wherein the material is Bizbenzocyclobutane (BCB).

37. The device of claim 23 wherein the laminate is a dry film resist or resist sheet.

38. The device of claim 23 further comprising a layer of solder mask disposed between the substrate and the laminate material disposed on the top surface of the substrate and a layer of solder mask disposed between the substrate and the laminate material disposed on the bottom surface of the substrate.

39. The device of claim 37 wherein the dry film resist is Vacrel or Riston film.

40. The device of claim 1 wherein the solder mask is Bizbenzocyclobutane (BCB).

41. The device of claim 17 wherein the solder mask is Bizbenzocyclobutane (BCB).

42. The device of claim 32 wherein the solder mask is Bizbenzocyclobutane (BCB).

43 A device for storing, transporting, mixing or analyzing biological or chemical materials comprising:
a patterned substrate having a top surface and a bottom surface, wherein a first pattern extends only partially into the substrate from the top surface, and a second pattern extends only partially into the substrate from the bottom surface
a laminate material disposed on the bottom surface of the substrate forming a bottom surface of the device.
a laminate material disposed on the top surface of the substrate forming a top surface of the device.

44. A device as in claim 8 wherein a bottom surface of the substrate forms a bottom surface of the device.

45. A device comprising:
a substrate having a top surface and a bottom surface;
a top layer of solder mask disposed on the top surface of the substrate, the top layer of solder mask having a top microfluidic groove;
a top layer of laminate disposed on the top layer of solder mask, the top layer of laminate and the top microfluidic groove together defining a top microfluidic channel;
a bottom layer of solder mask disposed on the bottom surface of the substrate, the bottom layer of solder mask having a bottom microfluidic groove; and
a bottom layer of laminate disposed on the bottom layer of solder mask, the bottom layer of laminate and the bottom microfluidic groove together defining a bottom microfluidic channel,

46. The device of claim 45 wherein the top microfluidic channel and the bottom microfluidic channel are coupled by a via extending through the substrate.

47. The device of claim 46 wherein the via is coated with a solder mask.

48. The device of claim 45 where the solder mask is Bizbenzocyclobutane (BCB).

49. The device of claim 8 further comprising at least one electrically conductive line intersecting the microfluidic channel.

50. The device of claim 49 wherein the at least one electrically conductive line forms part of the microfluidic channel

51. The device of claim 8 further comprising a means for applying electrical voltage to the microfluidic channel.

52. The device of claim 51 wherein the means is a pair of spaced apart electrically conductive traces.

53. The device of claim 1 further comprising at least one of the group consisting of an electronic, optoelectronic and optical device, secured to the device.

54. The device of claim 23 further comprising at least one of the group consisting of an electronic, optoelectronic and optical device, secured to the device.

55. The device of claim 8 further comprising an optical waveguide intersecting the microfluidic channel.

56. The device of claim 1 further comprising an optical waveguide intersecting the microfluidic channel.

57. The device of claim 45 further comprising an optical waveguide intersecting the top microfluidic channel.

58. The device of claim 55 wherein the optical waveguide comprises at least partially transparent solder mask material.

59. The device of claim 56 wherein the optical waveguide comprises at least partially transparent solder mask material.

60. The device of claim 57 wherein the optical waveguide comprises at least partially transparent solder mask material.

61. The device of claim 55 wherein the optical waveguide comprises first and second layers of solder mask wherein the first layer of solder mask has a lower index of refraction than the second layer of solder mask.

62. The device of claim 57 wherein the optical waveguide comprises first and second layers of solder mask wherein the first layer of solder mask has a lower index of refraction than the second layer of solder mask.

63. The device of claim 55 wherein sides of the waveguide are defined by an air-solder mask interface, a top of the waveguide is defined by an air-solder mask interface or an air-laminate interface, and a bottom of the waveguide is defined by a solder mask or metal.

64. The device of claim 57 wherein sides of the waveguide are defined by an air-solder mask interface, the top of the waveguide is defined by an air-solder mask interface or a air-laminate interface, and the bottom of the waveguide is defined by a solder mask or metal.

65. A method of forming a device for storing, transporting, mixing or analyzing biological or chemical materials comprising the steps of:
forming a microfluidic groove in a substrate; and
laminating the substrate to form a microfluidic channel.

66. The method of claim 65 wherein the step of laminating comprises disposing a sheet of photoresist or dry film resist on the substrate.

67. The method of claim 66 wherein the photoresist is at least partially transparent.

68. The method of claim 65 further comprising the step of:
forming a storage chamber in the substrate, the storage chamber communicating with the microfluidic channel.

69. The method of claim 65 wherein the step of forming comprises patterning a solder mask on the substrate.

70. The method of claim 65 wherein the step of forming comprises the steps of:
patterning a solder mask on the substrate; and
applying a layer of laminate on the patterned soldered mask.

71. The method of claim 69 wherein the solder mask is a dry film resist.

72. An assembly for analysis of biological or chemical materials comprising:
a substrate;
a layer of solder mask disposed on substrate, the layer of solder mask having a microfluidic groove;
a layer of laminate disposed on the layer of solder mask, wherein
a microfluidic channel is defined at least in part by the microfluidic groove and the layer of laminate;
a storage chamber communicating with the microfluidic channel;
a pair of collimators disposed at opposite ends of the storage chamber, wherein the collimators are substantially aligned on a common optical axis.

73. An assembly for the analysis of chemical or biological materials comprsing:
a substrate;
a layer of solder mask disposed on substrate, the layer of solder mask having a microfluidic groove;
a layer of laminate disposed on the layer of solder mask, wherein
a microfluidic channel is defined by the microfluidic groove and the layer of laminate;
a storage chamber communicating with the microfluidic channel; and
a thermoelectric heater/cooler secured to the substrate.

74. A method for forming two closely spaced electrically conductive lines as claimed in claim 49 wherein the two conducting lines are formed by precision laser cutting or ablating metal or metals comprising a single conducting line to form two conducting lines.

75. A biological or chemical sensor produced by forming at least two closely spaced conductive lines as claimed in claim 74.

76. A method for producing a hole or opening in a laminate layer of a micro-fluidic chamber as claimed in claim 8 to insert solid and/or liquid biological or chemical materials wherein the method comprises implements producing an opening of desired size in the laminate layer using a sterile punch.

77. A method for producing a hole or opening in a laminate layer of a micro-fluidic chamber as claimed in claim 30 to insert solid and/or liquid biological or chemical materials wherein the method comprises producing an opening of desired size in the laminate using a sterile punch.

78. The device of claim 31 further comprising a third storage chamber connected to the second storage chamber via a second micro-fluidic channel wherein a laminate covering the third storage chamber is depressible or deformable to produce a pressure on the second micro-fluidic channel and the second chamber to force contents of the second chamber to flow to the first chamber through the first micro fluidic channel.
